(19) United States
(12) Patent Application Publication
(10) Pub. No.: US 2005/0089284 A1
(43) Pub. Date: Apr. 28, 2005

(54) Light emitting cable wire

(76) Inventor: Ming-Chuan Ma, Taipei Hsien (TW)

Correspondence Address: BIRCH STEWART KOLASCH & BIRCH, PO BOX 747, FALLS CHURCH, VA, 22040-0747, US

(21) Appl. No.: 10/691,564

(22) Filed: Oct. 24, 2003

(51) Int. Cl. G02B 6/44

(52) U.S. Cl. 385/101

(57) ABSTRACT

A light emitting cable wire is described. A transparent isolation layer is coated on the cable wire. A signal wire, a power cord and an optical fiber are disposed underneath the transparent isolation layer. The circuit board has a light-emitting element formed thereon. One end of the cable wire is connected to circuit board and the other end of the cable wire has a plug. When the plug of the cable wire is fit into the corresponding slot of the computer, the light-emitting element will glow by the power of the power cord of the cable wire and the light emitted there-from gets reflected by the optical fiber and travels through optical fiber glowing the transparent isolation layer. This design not only allows users to identify the location of the cable wire but also provides an esthetic appearance to cable wire attracting the consumers.

### BACKGROUND OF THE INVENTION

1. The field of the invention

The present invention generally relates to a light emitting cable wire, and more particularly relates to a cable wire comprising a circuit board having a light-emitting element, and the light emitting element has an end supporting against an optical fiber, which extend under a transparent isolation layer of the cable wire, wherein the light emitted by the light-emitting element is reflected by the optical fiber and travels through the optical fiber and glow the transparent isolation layer.

2. Description of the Related Art

With rapid development in technology, the computer has become a modern essential household electronic product for watching TV, listening to music or working. The computer can be connect to a variety of peripheral devices, for example, CD ROM, printer, scanner, and alike. The above peripheral devices are connected to the computer by using cable wires, which are exposed outside and are prone to get loosen easily or experience signal interruptions caused by the external contact or pressure through the deformation of the cable wire connecting the peripheral devices. Taking the notebook computer as an example, the cable wire of the mouse has a plug to fit into the slot of the computer and the user has to repeat the plug-in and pull-out actions often, as a result, when a part of the plug or slot is damaged or loosen, the accuracy of data transmission from the peripheral device will be undesirably affected or even interrupted. Besides, the conventional cable wire doesn't contain identification function. The common cable wire is linked to the host from the rear side where it is usually dark, so without light or clear indication, the user often accidentally touch or kick the cable wire and thereby loosen the connections of the peripheral devices. Furthermore, when the user need to change the peripheral device, the user needs to pull out the cable wire, and because of the low visibility due to dim condition may lead the user to pull the wrong plug to cause data signal interruption or computer break down during the operation. Therefore, how to solve the above defects is an important issue for the manufacturer in the field.

### SUMMARY OF THE INVENTION

Accordingly, in the view of the foregoing, the present inventor makes a detailed study of related art to evaluate and consider, and uses years of accumulated experience in this field, and through several experiments, to create a new light emitting cable wire. The present invention provides an innovated, cost effective light emitting cable wire for connecting a variety of electronic devices such that the emitting cable can be easily located even in areas where the visibility is poor.

According to one aspect of the present invention, the cable wire is coated with a transparent isolation layer. A signal wire, a power cord and an optical fiber are disposed underneath the transparent isolation layer. The circuit board comprises a light-emitting element formed thereon. One end of the cable wire is connected to circuit board and the other end of the cable wire has a plug. When the plug of the cable wire is fit into the corresponding slot of the computer, the light-emitting element will glow by the power of the power cord of the cable wire and the light emitted there-from gets reflected by the optical fiber and travels through the optical fiber and glow the transparent isolation layer. This design not only allows users to identify the location of the light emitting cable wire but also provides an esthetic appearance to cable wire attracting the consumers.

### BRIEF DESCRIPTION OF THE DRAWING

For a more complete understanding of the present invention, reference will now be made to the following detailed description of preferred embodiments taken in conjunction with the accompanying drawings.

FIG. 1 is the elevational view of a light emitting cable wire of the present invention.

FIG. 2 is the elevational view I of a light emitting cable wire according to one preferred embodiment of the present invention.

FIG. 3 is the elevational view II of the light emitting cable wire according to one preferred embodiment of the present invention.

FIG. 4 is the elevational view III of the light emitting cable wire according to one preferred embodiment of the present invention.

FIG. 5 is the elevational view IV of the light emitting cable wire according to one preferred embodiment of the present invention.

FIG. 6 is the elevational view of a light emitting cable wire according to another preferred embodiment of the present invention.

FIG. 7 is the elevational view of a light emitting cable wire according to another preferred embodiment of the present invention.

FIG. 8 is the elevational view V of a light emitting cable wire according to another preferred embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

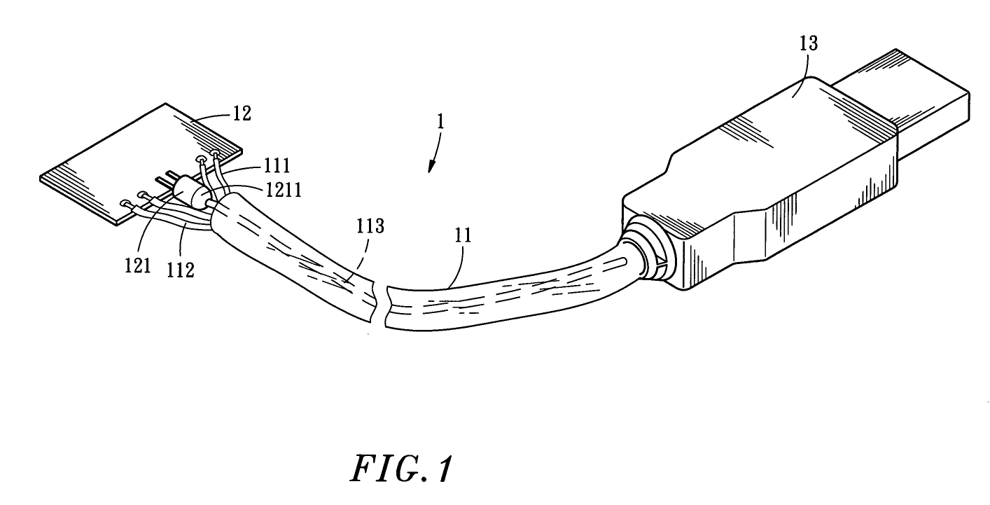

Referring to FIG. 1, the elevational view of a light emitting cable wire of the present invention is illustrated. As shown, the light emitting cable wire of the present invention comprises a cable wire 1, wherein the cable wire 1 is coated with an isolation layer 11. A signal wire 111, a power cord 112 and an optical fiber 113 are disposed under the isolation layer 11. The distal end of the cable wire 1 is jointed to a circuit board 12 having a light-emitting element 121 formed thereon. The light-emitting element 121 is connected to the power cord 112 inside the cable wire 1 through the circuit board 12. The terminal 1211 of the light-emitting element 121 is supported against the optical fiber 113 inside the cable wire 1. The other end of the cable wire 1 comprises a plug 13.

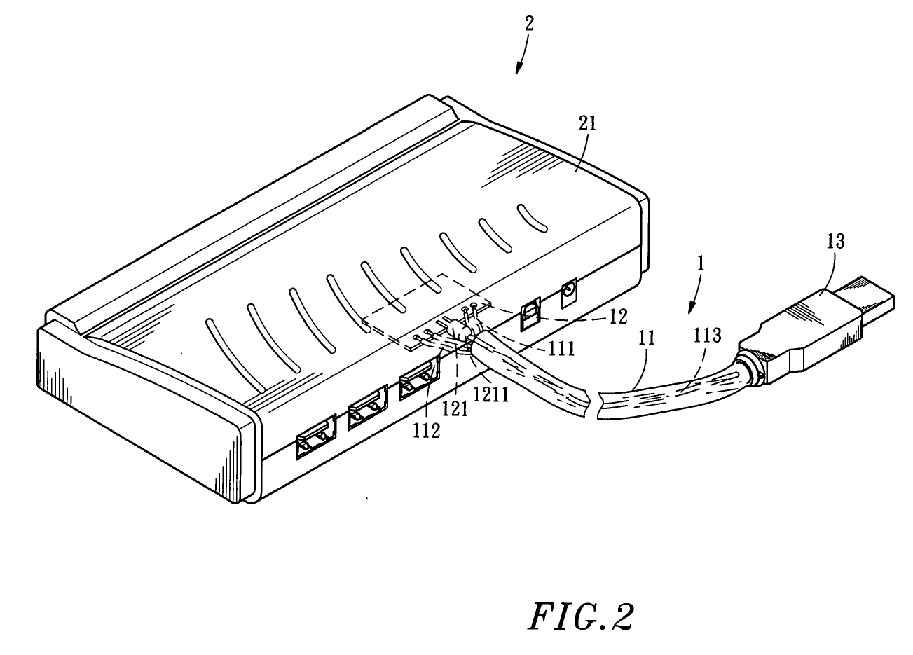

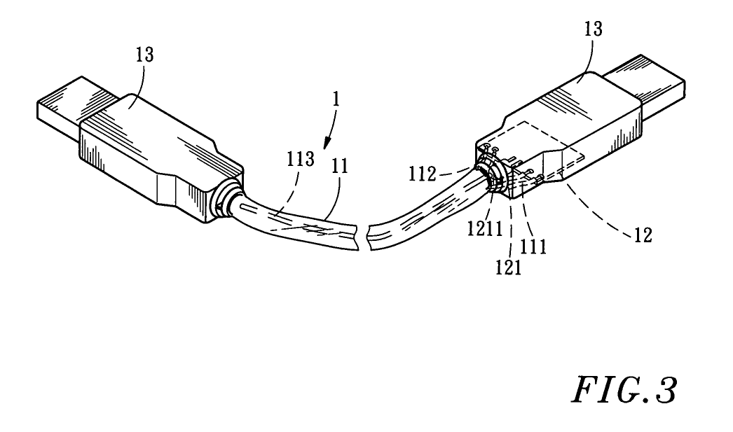

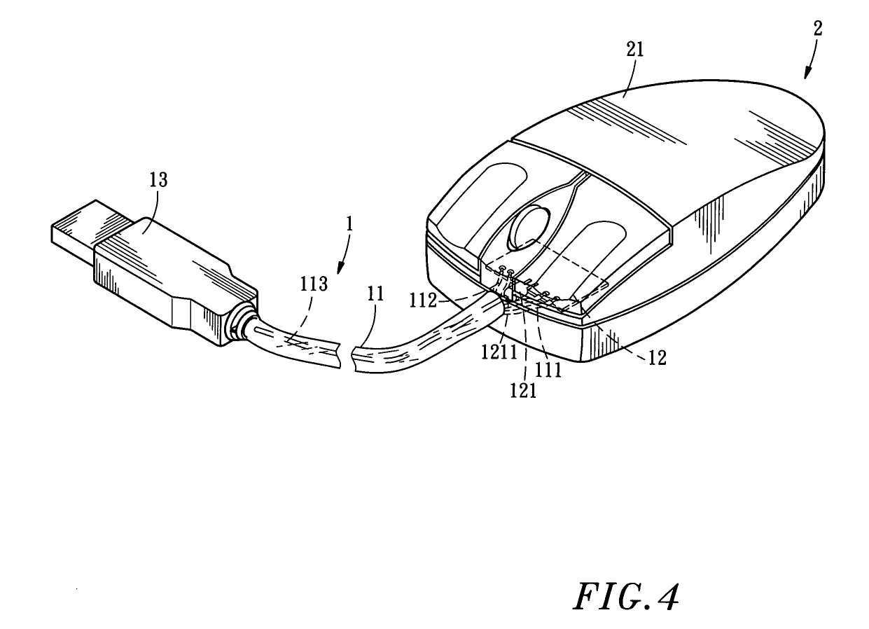

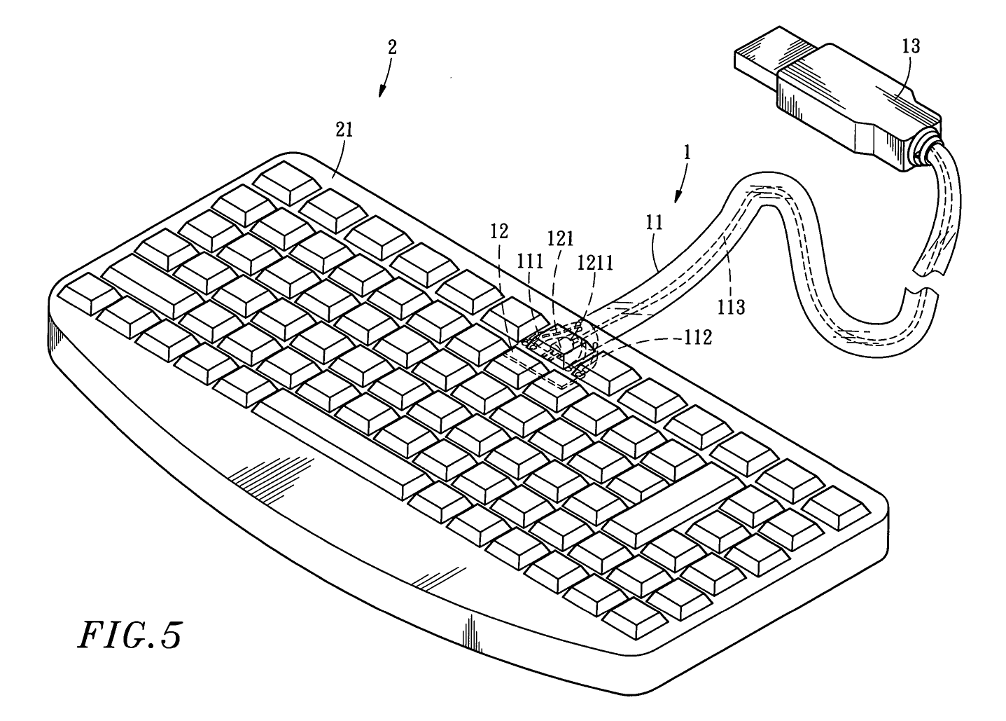

Referring to FIGS. 2, 3, 4 and 5, the elevational view I, II, III and IV of the light emitting cable wire according to one preferred embodiment of the present invention are shown. As shown, one end of the cable wire 1 is connected to the circuit board 12 installed within a case 21 of the peripheral device 2. The isolation layer 11 of the cable wire 1 is exposed out of the case 21 of the peripheral device 2. To operate the peripheral device 2, the plug 13 of the cable wire 1 is plugged into a corresponding slot located at the backside of the computer 3. Meanwhile, the light-emitting element 121 glows emitting light upon receiving the power through the power cord 112 of the cable wire 1. The emitted light is reflected by the optical fiber 113. The circuit required for the peripheral device 2 may be directly set on the circuit board 12.

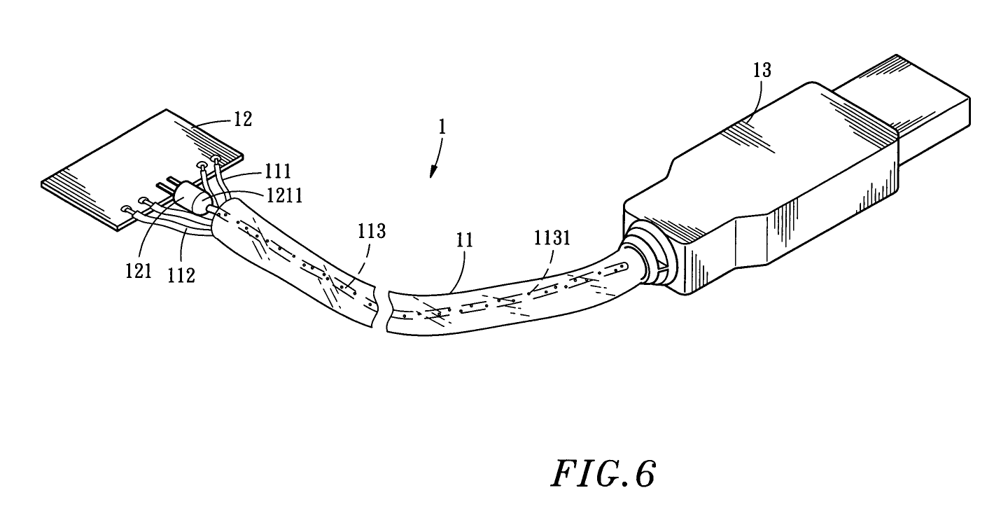

Referring to FIG. 6, the elevational view of a light emitting cable wire according to another preferred embodiment of the present invention is shown. As shown in FIG. 6, the optical fiber 113 may comprise a plurality of irregularly shaped indented spots 1131 on the surface thereof, wherein the light emitted by the light-emitting element 121 is reflected on the indented spots 1131 in order to create plurality light spots.

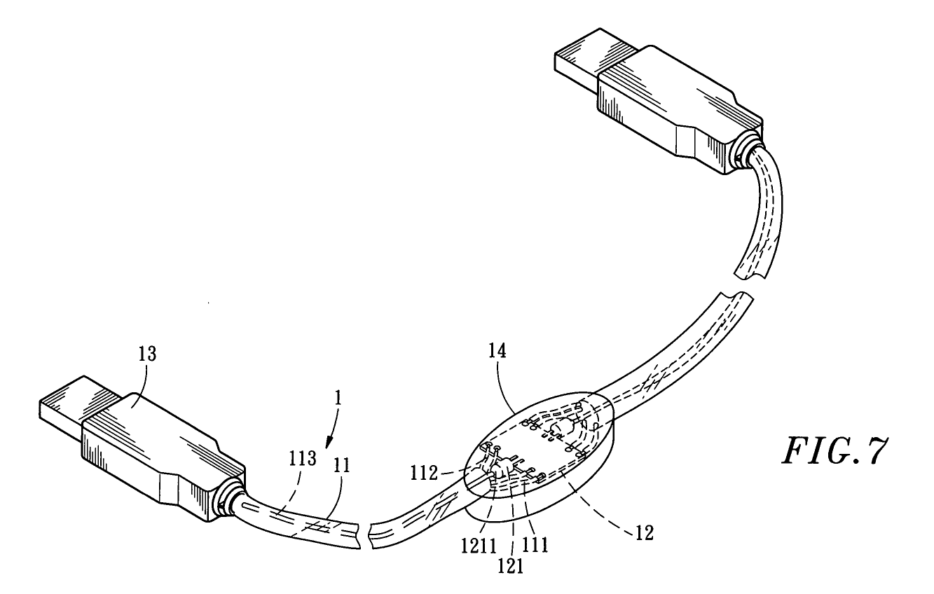

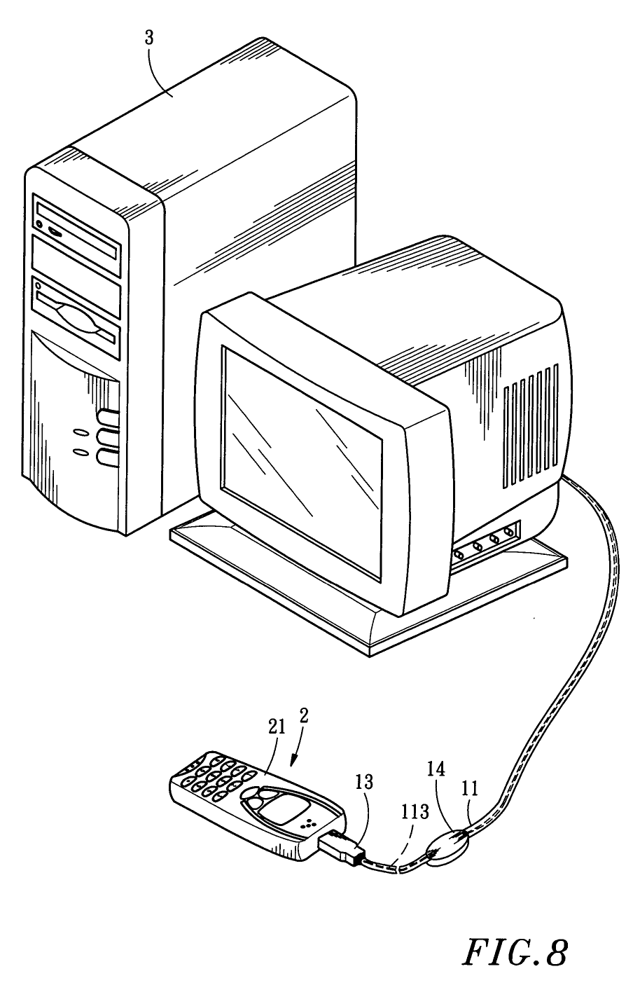

Further, referring to FIGS. 7 and 8, the elevational view of a light emitting cable wire according to another preferred embodiment and the elevational view V of a light emitting cable wire according to one preferred embodiment of the present invention, are shown. The circuit board 12 may be set between two ends of the cable wire 1 and being enclosed in a case 14. The two ends of the cable wire 1 may comprise a plug 13.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A light emitting cable wire, suitable for connecting a peripheral device to a computer, the light emitting cable wire comprising:
a cable wire;
a transparent isolation layer, coated onto the cable wire;
a signal wire, a power cord and an optical fiber, disposed underneath the transparent isolation layer; and
a circuit board, having a light emitting element, wherein one of said cable wire is connected to said circuit board with a light-emitting element, and another thereof comprises one or more plugs, wherein said light-emitting element is connected to said power cord through a circuit of said circuit board and one end of said light-emitting element is supported against said optical fiber, said plug of said cable wire can fit into a corresponding slot of said peripheral device, and wherein said light-emitting element emits light upon receiving the power through said power cord and the emitted light is reflected by said optical fiber and thereby glow said transparent isolation layer.

2. The light emitting cable wire according to claim 1, wherein said light-emitting element is comprised of a light-emitting diode.

3. The light emitting cable wire according to claim 1, wherein the material of said isolation layer is comprised of a semi-transparent material.

4. The light emitting cable wire according to claim 1, wherein the material of said isolation layer is comprised of a transparent material.

5. The light emitting cable wire according to claim 1, wherein said optical fiber comprises plurality indented spots.

6. The light emitting cable wire according to claim 1, wherein said circuit board can be installed within said peripheral device.

7. The light emitting cable wire according to claim 1, wherein said peripheral device can be a hub.

8. The light emitting cable wire according to claim 1, wherein said peripheral device can be a keyboard.

9. The light emitting cable wire according to claim 1, wherein said peripheral device can be a mouse.

10. The light emitting cable wire according to claim 1, wherein said light emitting cable wire can be an USB data transmission wire.
